(19) United States
(12) Patent Application Publication
(10) Pub. No.: US 2013/0056294 A1
(43) Pub. Date: Mar. 7, 2013

(54) STEERING DEVICE FOR A VEHICLE

(71) Applicant: Torsten Henke, Waiblingen (DE)

(72) Inventor: Torsten Henke, Waiblingen (DE)

(73) Assignee: ROBERT BOSCH GMBH, Stuttgart (DE)

(21) Appl. No.: 13/579,176

(22) PCT Filed: Jan. 26, 2011
(86) PCT No.: PCT/EP2011/051018

§ 371 Date: Nov. 12, 2012

(30) Foreign Application Priority Data
Feb. 15, 2010 (DE) 10 2010 001 911.9

(51) Int. Cl. B62D 5/04

(52) U.S. Cl. 180/446; 180/443

(57) ABSTRACT

The invention relates to a steering device for a vehicle, comprising a steering drive (1) having an output shaft (2) for assisting a steering process, and a blocking device (3) for blocking the steering drive (1). Said blocking device (3) is directly arranged on the steering drive (1) and blocks the steering drive directly on the output shaft (2). The invention also relates to a method for blocking a steering device.

### BACKGROUND OF THE INVENTION

The present invention relates to a steering device for a vehicle and to a method for blocking a steering device.

Recently, steering devices with an assistance means, for example electric power steering systems, have been used in virtually all vehicles. In such electric power steering systems, a sensor usually detects a steering process of a driver and controls, via a control unit, an electric motor which is arranged on the steering column or on a steering linkage. This electric motor then generates a corresponding torque in order to assist the steering process. However, in hazardous situations it is necessary to ensure that the steering device is blocked. This has previously been achieved with separate electric steering wheel locking systems which are mounted on the steering column and which have a perforated wheel and an electrically operated actuator which can be engaged with the perforated wheel. However, the known solutions are relatively complex and require, in particular, additional installation space.

### SUMMARY OF THE INVENTION

The steering device according to the invention has, in contrast, the advantage that it makes available a very compact and space-saving solution for blocking of the steering device, wherein, according to the invention, a blocking device is arranged directly on a steering drive of an electric power steering system. In this context, the blocking device blocks the steering drive immediately at an output shaft of the steering drive. As a result, a simple and cost-effective solution for the blocking device can be made available in order, for example, to block the steering drive in hazardous situations and therefore prevent assistance by the steering drive. In addition, the steering drive and the blocking device can be made available as a module which can be mounted, as a result of which both the manufacturing costs and assembly costs of vehicle manufacturers can be reduced. The steering drive can be arranged on a steering column or on a steering linkage.

The blocking device preferably comprises a blocking fork with two arms by means of which the output shaft is blocked. For this purpose, the output shaft preferably has two flattened regions for contact with the arms of the blocking fork or the output shaft comprises an additional adapter with two flattened regions for engagement with the two arms, wherein the adapter is, for example, fitted onto the blocking shaft. In this context, a press fit between the adapter and the output shaft can for example be provided.

More preferably, the blocking device is arranged on the steering drive in such a way that a movement direction of the blocking device is perpendicular to the central axis of the output shaft.

According to a further preferred refinement of the invention, the steering device also comprises a locking device which blocks a position of the blocking device. As a result, an additional safety feature is provided since the blocking device for its part is itself also locked by the locking device. As a result, even in extreme situations secure blocking of the steering device can be achieved. The locking device particularly preferably comprises in this context a locking slide or a hook in order to block the blocking device. As a result, the locking device can be constructed in a very simple and cost-effective way. In this context, the locking device can engage on the blocking device at any desired position. The locking device preferably engages in the region of a blocking fork or of a connection between the blocking fork of a connection, between the blocking fork and a base body of the blocking device. Alternatively, the locking device can also engage on a housing of the blocking device and lock the blocking device.

In order to permit a further reduction in costs, a common control device is preferably provided for the steering drive and the blocking device. If, in addition, a locking device is also provided, said locking device is preferably also controlled by the common control device. The control device is particularly preferably configured here in such a way that when a blocking device and a locking device are present the locking device is activated after the blocking device. As a result, locking of the blocking device in a state in which the blocking device does not block the output shaft is prevented.

The locking device more preferably comprises a diagnostic device for checking successful locking of the blocking device. The diagnostic device preferably monitors a power drain of the locking device, preferably by means of power/time profile curves or by detecting a power flow after contact of the blocking device with the output shaft. It is also to be noted that the locking device is preferably also activated in a chronologically offset fashion when the blocking device is activated.

The blocking fork is preferably configured in such a way that similarly to a principle of a slipping clutch, said blocking fork permits the output shaft to spin when a predetermined torque absolute value occurs. For this purpose, the blocking fork preferably has two arms which are secured to a base in an articulated fashion and which are held in position by means of spring force. If a predetermined torque is exceeded at the output shaft, the two arms spread apart outward counter to the spring force and the output shaft continues to rotate. By means of these measures it is possible, in particular, to avoid damage to the blocking device owing to the occurrence of an excessively large torque at the output shaft.

Furthermore, the present invention relates to a method for blocking a steering device, wherein the blocking occurs immediately at an output shaft of a steering drive. After the blocking of the output shaft by means of the blocking device, the blocking device is particularly preferably also locked by means of a locking device. In this context the steering drive and the blocking device and, if appropriate, the locking device are also more preferably actuated by means of a common control device, wherein, in particular, the locking device is activated after activation of the blocking device.

### BRIEF DESCRIPTION OF THE DRAWINGS

Preferred exemplary embodiments of the invention are described in detail below with reference to the appended drawing. In the drawing:

FIG. 1 is a schematic sectional view of a steering device according to an exemplary embodiment of the invention,

FIG. 2 is a schematic side view of a blocking device from FIG. 1,

FIG. 3 is a schematic sectional view of a steering device according to a second exemplary embodiment in a non-blocked state,

FIG. 4 is a schematic sectional view of the steering device from FIG. 3 in a blocked state, and

FIG. 5 is a schematic sectional view of a steering device according to a third exemplary embodiment of the invention in a non-blocked state.

### DETAILED DESCRIPTION

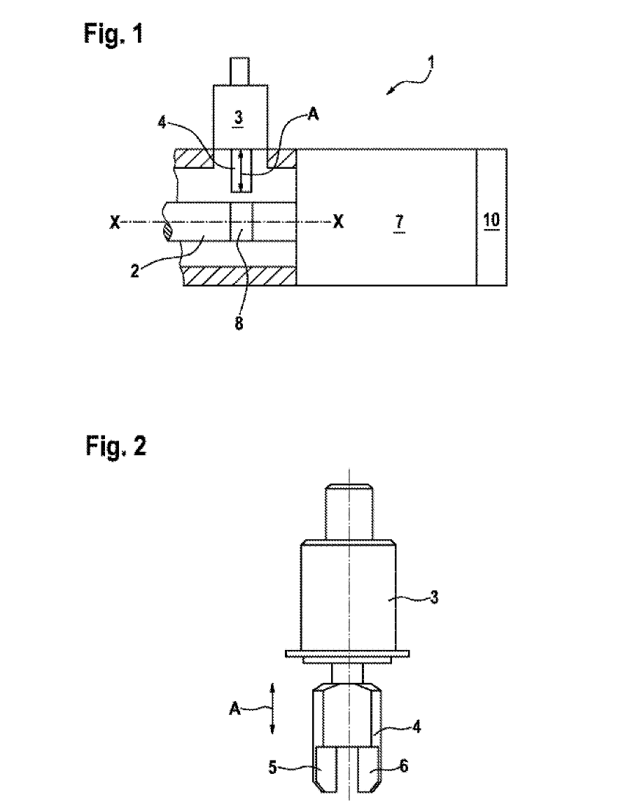

A steering device for a vehicle according to a first exemplary embodiment of the invention will be described in detail below with reference to FIGS. 1 and 2.

As is apparent from FIG. 1, the steering device for a vehicle comprises a steering drive 1 with a drive motor 7 and an output shaft 2. The output shaft 2 is connected to a steering shaft or a steering linkage in order to permit power assistance during a steering process. The steering drive 1 is therefore an electric power steering system for assisting a steering process. The output shaft 2 of the steering drive 1 is connected here via a transmission to the steering linkage or the steering column (not shown). In addition, the steering device of this exemplary embodiment comprises a blocking device 3 with a blocking fork 4. The blocking device 3 is shown in detail in FIG. 2. The blocking device 3 is also an electric actuator and permits the blocking fork 4 to be moved linearly as indicated by the double arrow A. The blocking fork 4 comprises here a first arm 5 and a second arm 6, which are arranged at the free end of the blocking fork 4.

As is also apparent from FIG. 1, flattened regions are provided in the output shaft 2 at the level of the blocking device 3. In this context, only a flattened region 8 can be seen in FIG. 1 since the other flattened region is arranged on the rear side of the output shaft 2 which is not shown. Two recesses, in which the arms 5, 6 of the blocking fork 4 can engage, are therefore formed on the flattened regions 8 in the output shaft 2. The direction A of movement of the blocking fork 4 is perpendicular here to a central axis X-X of the output shaft 2 (cf. FIG. 1).

FIG. 1 shows the non-blocked state of the output shaft 2. If, for example, a hazardous situation is then present and the steering drive 1 is to be blocked, a control device 10, integrated in the steering drive 1, activates the blocking device 3, with the result that said blocking device 3 engages the blocking fork 4 with its arms 5, 6 on the flattened regions 8 in the output shaft 2. As a result, direct engagement of the blocking device 3 in the output shaft 2 is brought about and rotation of the output shaft 2 is prevented. The blocking device 3 preferably also comprises here an electromagnetic drive. In order to release the blocking device 3, the drive of the blocking device 3 is driven in the reverse direction, with the result that the blocking fork 4 again becomes disengaged from the output shaft 2.

A particularly compact and cost-effective design is achieved by the inventive direct blocking of the output shaft 2 by means of the blocking device 3. The blocking device 3 is integrated here into the steering drive 1 and is controlled by means of a common control device 10. As a result, a compact module for the electric power steering system with integrated blocking device can be made available, which module is easy to mount on various vehicles.

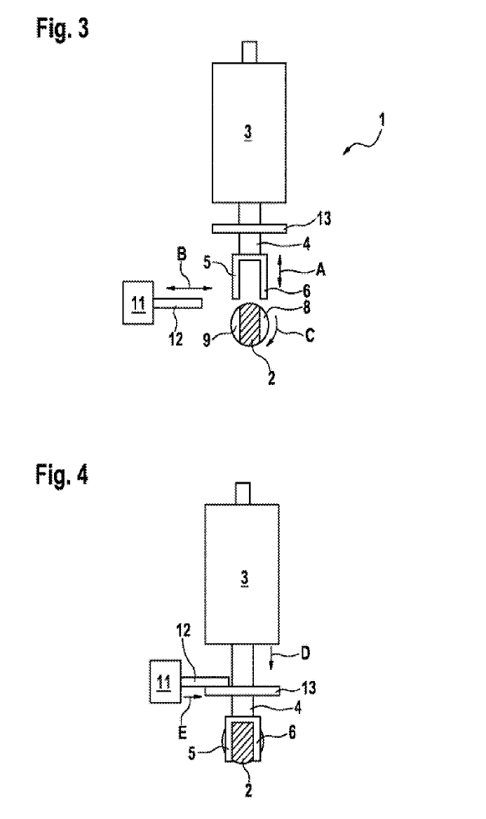

FIGS. 3 and 4 show a steering drive according to a second exemplary embodiment of the invention, wherein identical or functionally identical parts are denoted by the same reference symbols as in the first exemplary embodiment.

The steering drive 1 of the second exemplary embodiment additionally comprises a locking device 11 which, like the blocking device 3, is integrated into the steering drive 1. The locking device 11 has here the function of ensuring locking of the blocking device 3 when the latter blocks the output shaft 2. The locking device 11 comprises here a protruding element 12 in the form of a pin which, as indicated by the double arrow B, can be moved in the perpendicular direction with respect to a direction A of movement of the blocking fork 4. As in the first exemplary embodiment, a first and a second flattened region 8, 9 is provided in the output shaft 2, on which regions 8, 9 the arms 5, 6 of the blocking fork 4 can engage directly in the output shaft 2. Rotation of the output shaft 2 is indicated by the arrow C. The locking device 11 permits redundant securing of the blocked state of the output shaft 2 of the steering drive.

If, for example, a hazardous situation occurs, the blocking device 3 is activated and moves, as indicated by the arrow D in FIG. 4, perpendicularly with respect to the central axis of the output shaft 2. In this context, the arms 5, 6 of the blocking fork enter into engagement with the flattened regions 8, 9 of the output shaft 2. A circumferential flange 13 is provided on the blocking fork 4, which flange 13 is configured to enter into contact with the protruding element 12 of the locking device 11. As is apparent from FIG. 4, after the end position of the blocking device 3 has been reached the locking device 11 is activated, with the result that the protruding element 12 is moved in the direction of the arrow E, perpendicularly with respect to the direction A of the movement of the blocking fork 4. In this context, the protruding element 12 engages behind the flange 13, with the result that the blocking device 3 can no longer be reset. The locking device 11 is preferably controlled here by means of a common control device, which also controls the blocking device 3 and the steering drive. In this context, a diagnostic device (not illustrated) can also be integrated into the common control device in order to reliably detect a satisfactory activation of the locking device 11 and therefore locking of the blocking device 3. As a result, in the second exemplary embodiment an additional safety device is used in order to prevent undesired drive of the output shaft 2. The locking device 11 engages here immediately in the blocking fork 4. However, it is to be noted here that the locking device 11 can also engage at other positions on the blocking device 3, for example in the region of the arms 5, 6 or in the region of the drive of the blocking device 3. As a result, the second exemplary embodiment presents a compact module which comprises not only the steering drive but also a blocking device 3 and a locking device 11 as an additional safety device.

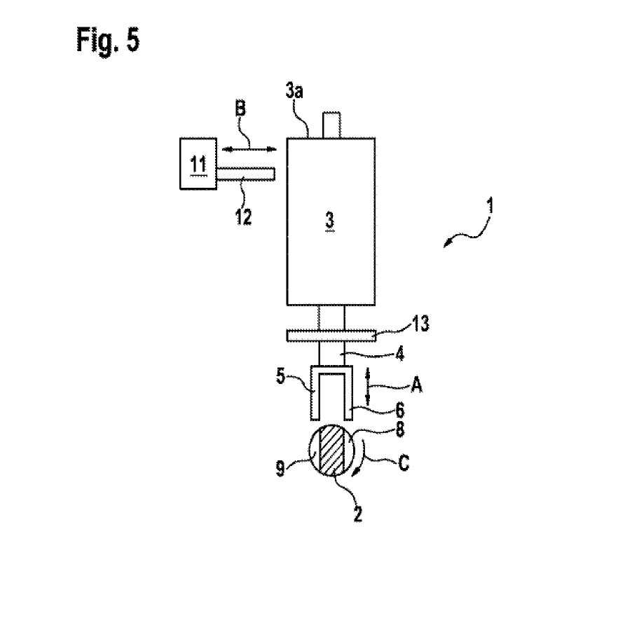

FIG. 5 shows a steering drive according to a third exemplary embodiment of the invention, wherein identical or functionally identical parts are again denoted by the same reference symbols as in the preceding exemplary embodiments.

As is apparent from FIG. 5, the third exemplary embodiment corresponds substantially to the second exemplary embodiment, wherein a position of the locking device 11 is different from the second exemplary embodiment. To be more precise, as is apparent from FIG. 5, the locking device 11 is arranged in a housing of the blocking device 3, and the locking device therefore locks the blocking device 3 at a rear housing region 3a when the blocking device enters into engagement with the output shaft 2. Otherwise, this exemplary embodiment corresponds to the preceding exemplary embodiments, with the result that reference can be made to the description given there.

With respect to all the exemplary embodiments described it is to be noted that an alternative design can be implemented by virtue of the fact that the arms 5, 6 of the blocking fork 4 can be pivotably arranged at a base region which connects the arms 5, 6. The arms 5, 6 are connected to one another here, for example by means of a spring element. If a torque on the output shaft 2 becomes too large, the arms 5, 6 can spread apart, with the result that damage to the output shaft or the blocking fork can be avoided. The spring between the arms 5, 6 then resets the arms back into the home position when the output shaft 2 has been rotated through 180°.

1. A steering device for a vehicle, comprising
a steering drive (1) having an output shaft (2) for assisting a steering process, and
a blocking device (3) for blocking the steering drive (1),
wherein the blocking device (3) is arranged directly on the steering drive (1) and blocks the steering drive immediately at the output shaft (2).

2. The steering device as claimed in claim 1, characterized in that the blocking device (3) comprises a blocking fork (4) with two arms (5, 6), and the output shaft (2) has two flattened regions (8, 9) for contact with the arms (5, 6) of the blocking fork (3).

3. The steering device as claimed in claim 1, characterized in that a movement direction (A) of the blocking device (3) is perpendicular to a central axis (X-X) of the output shaft (2).

4. The steering device as claimed in claim 1, also comprising a locking device (11) which locks a position of the blocking device (3).

5. The steering device as claimed in claim 4, characterized in that the locking device (11) comprises one of a locking slide (12) and a hook.

6. The steering device as claimed in claim 1, comprising a common control device which is configured to control the steering drive (1) and the blocking device (3).

7. The steering device as claimed in claim 6, characterized in that the control device is configured to control the locking device.

8. The steering device as claimed in claim 4, also comprising a diagnostic device for checking successful activation of the locking device (11).

9. (canceled)

10. (canceled)

11. (canceled)

12. The steering device as claimed in claim 1, characterized in that the blocking device (3) comprises a blocking fork (4) with two arms (5, 6), and the output shaft (2) has an additional adapter with two flattened regions (8, 9) for contact with the arms (5, 6) of the blocking fork (3).

13. The steering device as claimed in claim 6, characterized in that the control device is configured to control the locking device, wherein the locking device (11) can be activated after the blocking device (3).

14. The steering device as claimed in claim 4, also comprising a diagnostic device for checking successful activation of the locking device (11), wherein the diagnostic device checks a power drain of the locking device.

15. A method for blocking a steering device of a vehicle, comprising
providing a steering drive (1) having an output shaft (2) for assisting a steering process, and
blocking the steering device immediately at the output shaft (2) of the steering drive (1).

16. The method as claimed in claim 15, comprising blocking the output shaft of the steering drive by means of a blocking device (3), and thereafter locking the blocking device (3) by means of a locking device (11).

17. The method as claimed in claim 15, characterized in that at least one of the steering drive (1), the blocking device (3) and the locking device (11) is controlled by a common control device.

18. The method as claimed in claim 15, characterized in that the steering drive (1), the blocking device (3) and the locking device (11) are controlled by a common control device.
